(19) United States
(12) Patent Application Publication
(10) Pub. No.: US 2025/0095094 A1
(43) Pub. Date: Mar. 20, 2025

(54) SYSTEMS AND METHODS FOR SECURE TICKETING GENERATION AND VALIDATION

(71) Applicant: Scantech Innovations LLC, Newark, DE (US)

(72) Inventors: Daniel Cohen, Great Neck, NY (US); Eitan Cohen, Great Neck, NY (US); Gilead Prigan, Great Neck, NY (US); Joshua Fischler, New York, NY (US)

(21) Appl. No.: 18/368,965

(22) Filed: Sep. 15, 2023

(51) Int. Cl. G06Q 50/26; G06K 19/06; H04L 9/32

(52) U.S. Cl. CPC G06Q 50/265; G06K 19/06028; G06K 19/06037; G06K 19/06112; H04L 9/3213; H04L 9/3268; G06Q 2220/10

(57) ABSTRACT

This application relates to a secondary token server and method of use thereof. The method includes receiving, by the secondary token server, a credential from a user device and corresponding to a credential owner. The method further includes validating, by the secondary token server, that the credential owner has ownership of the token, wherein validating comprises transmitting a request to a primary token server to authenticate the credential and the token. The method further includes generating, by the secondary credential server, an identifier that provides access to a certificate corresponding to the token and corresponding to a security component, wherein the security component rotates the certificate at a predetermined time interval. The method further includes providing, by the secondary token server, the identifier to the user device corresponding to the credential owner.

### TECHNICAL FIELD

The present disclosure relates to ticket generation. More particularly, the present technology is related to the technical field of systems and methods for generating and verifying tickets for events and/or venues.

### BACKGROUND

As authentication and access control to events and facilities becomes increasingly important to manage security and deny access to unauthorized persons, many solutions have been pursued. The widespread use of mobile user devices such as smart phones has enabled authentication and access control technologies to move paper ticket technologies into digital technologies such as bar codes, Quick Response (QR) codes, and tokens (e.g., near field communication).

These digital technologies are broadly categorized into two approaches. The first existing approach includes a visual presentation of machine-readable information that is presented by the mobile user device, such as a static barcode or a static QR code. These visual presentations became a preferred technology due to the scalability and available delivery methods. A challenge of these static barcodes or static QR codes is the ability to duplicate the image without. The ability to duplicate codes can cause failures in security of the token and lead to fake tokens or unauthorized copies being produced or even provided access erroneously.

The second approach includes a contactless tokenized data (via NFC of the mobile user device) such as a digital wallet application (e.g., Apple Wallet or Google Wallet). While tokenized data provides storage of the token on the mobile user device, challenges remain to reliability. The digital wallet applications that contain the tokenized data are not available on all mobile user devices, there may be authentication challenges with adding the tokenized data to the digital wallet application (e.g., biometric recognition failure, passcodes, etc.). As an additional challenge, NFC approaches can suffer from interference by certain metal surfaces or electronic devices that are operating in the vicinity.

### SUMMARY

Parties that own electronic tickets desire means for selling their tickets. Modern electronic tickets are often hard for users to sell because the tickets are locked into proprietary systems. Accordingly, there is a need for a federated way for people to sell and exchange electronic tickets. The present application discloses technical systems and methods for verifying ticket ownership and allowing for transfer of ownership using electronic means. The technical problem includes confirming ownership, creating a new token corresponding to the ticket, and generating a means for transferring the token to one or more downstream users via electronic means, such as a hyperlink or other token.

In an embodiment, the system and method includes receiving, by a secondary token server, a credential corresponding a credential owner from a user device. The method further includes validating, by the secondary token server, that the credential owner has ownership of a token corresponding to an event, wherein validating comprises transmitting a request to a primary token server to authenticate the credential and token. The method further includes generating, by the secondary token server, an identifier that provides access to the token and corresponding to a security component, wherein the security component rotates a certificate corresponding to the token at a predetermined time interval. The method further includes providing, by the secondary token server, the identifier to the user device corresponding to the credential owner.

### BRIEF DESCRIPTION OF THE DRAWINGS

The present invention is further described in the detailed description, which follows, in reference to the noted plurality of drawings by way of non-limiting examples of certain embodiments of the present invention, in which like numerals represent like elements throughout the several views of the drawings, and wherein:

FIG. 1 illustrates a token management system including a primary token server and a secondary token server according to embodiments of the present disclosure.

FIG. 2 depicts a method of token management according to embodiments of the present disclosure.

FIG. 3 depicts a graphical user interface of a user device for the token management system according to embodiments of the present disclosure.

FIGS. 4-6 depict interactive features of the graphical user interface for the token management system according to embodiments of the present disclosure.

### DETAILED DESCRIPTION

A detailed explanation of the apparatus, systems, methods, and illustrative embodiments of the present invention are described below. Numerous specific details are set forth in order to provide a thorough understanding of embodiments of the invention. However, it will be understood by ordinary artisans that embodiments of the present invention may be practiced without these specific details. In other instances, well-known methods, procedures, and components have not been described in detail so as not to obscure the present invention.

As used herein, “token” means a seed or secret key that may include a string of characters that is used to generate a certificate. As used herein, a “certificate” means a bar code, QR code, or access authorization (e.g., a near field communication authorization) corresponding to an event that requires a certificate for access. To limit the ability to duplicate static bar codes or QR codes discussed above, a rotating code functionality can be applied to the certificate. The rotating code functionality provides an additional security measure that makes it difficult to duplicate the certificate. The rotation functionality is configured to provide rotation at specific time intervals such that the rotation provides confirmation the authenticity of a certificate (e.g., an event ticket) in real-time or near real-time. In some cases, the rotation functionality can continuously update a visual presentation of the certificate on the mobile user device. In combination, utilization of digital wallets and/or dynamic/rotating barcodes can ensure a more secure source of ticket information. Digital wallets store the information on a smart-device and communicate with the central server to verify the authenticity of the information via secured tokens, making duplication of certificates or tickets more difficult and simplifying ticket retention for the end user. Present embodiments of the rotating barcode technology can also allow the system to function offline and still maintain the same level of security as the original vendor desired. Tickets accessed via web-link need not be locked by any account or app. Tickets can be saved and used offline by any user without the need to gather personal information. The system can be API accessible, allowing for bulk scanning and/or bulk ticket generation.

Techniques, methods, and systems described herein can be implemented using computer-based systems and methods. The technology can be implemented on a variety of hardware devices, including computers, smartphones, wearables (e.g., smart watches, step tracking bands, etc.), and tablets. A system can include hardware components and software that work together to perform a variety of tasks. Hardware components can include a processor, memory, storage, and input/output devices. The processor can be responsible for executing instructions and performing calculations. Memory, also known as RAM, can be used to store data and instructions that the processor uses.

User devices can have input/output devices such as a display and touchscreen, keyboard, or mouse to allow the user to interact with the technology. The devices can have a camera or scanner capable of reading barcodes to use the rotating barcode feature. The devices can have NFC capabilities for a contactless tokenized data feature. The system can be designed to be user-friendly and does not require users to create or access an account or install third-party applications. It can be available to devices running various operating systems, such as Android and iOS.

User device and/or the system hardware can include a general-purpose computer, a server, network, and/or cloud infrastructure and can have internal and/or external memory for storing data and programs such as an operating system (e.g., Windows, OS/2, UNIX, Linux, Android, or iOS) and one or more application programs. Examples of application programs can include computer programs implementing the techniques described herein for customization, authoring applications (e.g., database programs, spreadsheet programs, or graphics programs) capable of generating electronic content; client applications (e.g., an Internet Service Provider (ISP) client, an e-mail client, short message service (SMS) client, or an instant messaging (IM) client) capable of communicating with devices, accessing various computer resources, and viewing, creating, or otherwise manipulating electronic content; and browser applications capable of rendering standard Internet content and other content formatted according to standard protocols such as the HTTP. One or more of the application programs can be installed on the internal or external storage of the general-purpose computer. Alternatively, application programs can be externally stored in or performed by one or more device(s) external to the general-purpose computer.

The computer preferably includes input/output interfaces that enables wired and/or wireless connection to various devices. In one implementation, a processor-based system of the computer can include a main memory, preferably random-access memory (RAM), and can also include secondary memory, which may be a tangible computer-readable medium.

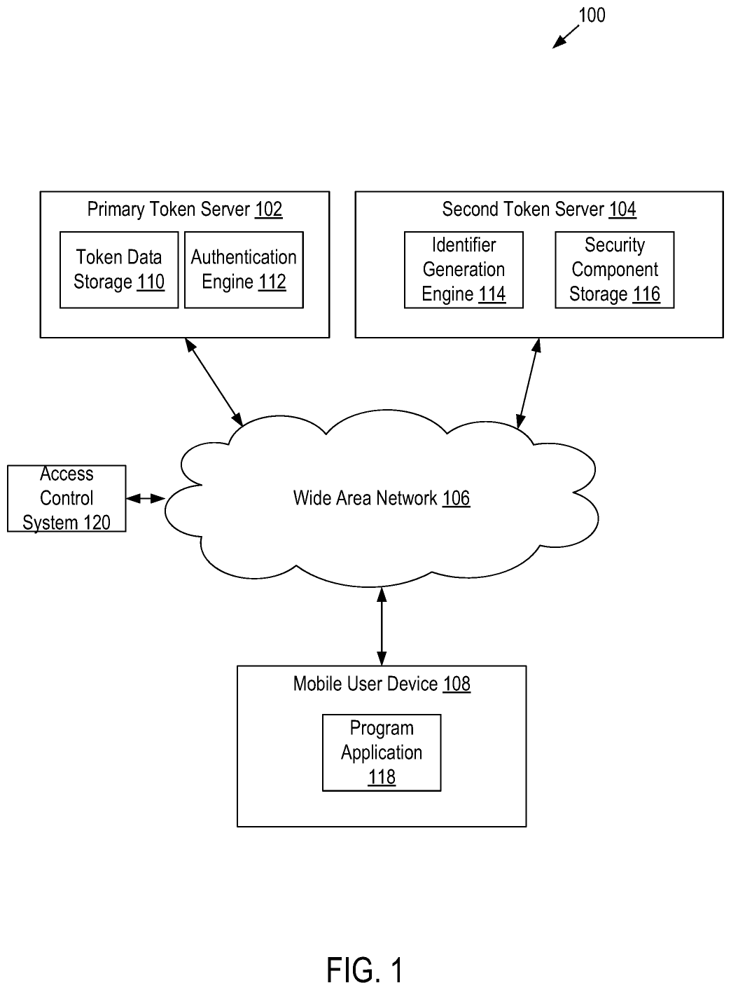

FIG. 1 illustrates an example of a system including a secondary token server according to aspects of the present disclosure. The token management system 100 includes a primary token server 102, a secondary token server 104, a wide area network 106, and a mobile user device 108. The primary token server 102 can include token data storage 110 and authentication engine 112. The secondary token server can include identifier generation engine 114 and security component storage 116. The mobile user device 108 can include a program application 118.

The primary token server 102 is a server system for authenticating and authorizing users and granting access based on the authorizations. The primary token server 102 is configured to receive a request for a token from a mobile user device 108. The request for the token may include an authentication credential such as a username/password, digital certificate, or payment data such as a receipt, payment card details, or other information associated with an owner of the mobile user device 108. In an example, the primary token server is configured to be accessed by the mobile user device 108 via an application program interface (API), a web browser application, or a program application installed on the mobile user device.

The primary token server 102 includes token data storage 110. The token data storage 110 may include multiple available tokens that correspond to an event. For example, the primary token server 102 may have multiple events that each have a set of tokens that may be provided in response to an authorized transaction. The mobile user device 108 may submit payment data and a corresponding event and receive, in response to the submitted payment data, a token corresponding to the event. Each of the tokens can be used to generate a certificate such as a bar code or QR code.

The primary token server 102 includes the authentication engine 112. The authentication engine 112 can validate an identification associated with the mobile user device 108. For instance, the authentication engine 112 can receive images of government or privately generated identification of the owner of the mobile user device (e.g., driver's license, school ID, military ID, etc.). The authentication engine 112 can restrict the tokens from being accessible to the mobile user device 108 until the identity is validated such as events that have age restrictions, location restrictions, or other authorization restrictions. The mobile user device 108 receives the token from the primary token server 102 after satisfying authentication engine 112.

The secondary token server 104 is configured to receive the token corresponding to the event from the mobile user device 108 corresponding to a token owner. In some embodiments, the secondary token server 104 may request additional information such as the user account/password, digital certificate, or identity information corresponding to the owner of the mobile user device. The secondary token server 104 validates that the token owner has ownership of the token by transmitting a validation request to a primary token server 102 to authenticate the token. Similar to as described above, the secondary token server 104 transmits a request including the token, the user account/password, digital certificate, or identity information corresponding to the owner of the mobile user device. In response to the request, the secondary token server 104 receives an indicator that the token is validated. In some embodiments, the indicator may be a confirmation code, a transaction identifier, or other indicator that validates that the token is authentic and corresponds to the event.

The secondary token server 104 is further configured to generate an identifier that provides access to the token corresponding to a security component. The identifier may be a uniform resource locator (URL) that retrieves a web-based representation of the certificate (e.g., a webpage that includes executable code to display a visual presentation of the credential generated from the token). The security component may be a code element embedded in the webpage or downloadable package to the browser application of the mobile user device. The security component rotates the certificate at a predetermined time interval to prevent or limit duplication by the mobile user device. After generating the identifier, the secondary token server 104 provides the identifier to the mobile user device corresponding to the token owner. The secondary token server 104 provides the identifier by sending the identifier to the mobile user device. In some embodiments, the secondary token server 104 provides the identifier to the web browser of the mobile user device.

In some embodiments, the secondary token server 104 is configured to transfer the token to an additional user device upon receipt of instructions from the token owner which may be received from the web browser of the mobile user device associated with the token owner. For example, the mobile user device communicates a request to transfer the identifier from the mobile user device to an additional user device. In response to the request, the secondary token server 104 provides the identifier to the additional user device without communication to the primary token server 102.

The primary token server 102 and the secondary token server 104 can communicate using a network, for example, the Internet, the World Wide Web, WANs, LANs, analog or digital wired and wireless networks (e.g., Public Switched Telephone Network (PSTN), Integrated Services Digital Network (ISDN), Digital Subscriber Line (xDSL)), radio, cable, or satellite systems, and other delivery mechanisms for carrying data. A communications link can include communication pathways that enable communications through one or more networks.

The mobile user device 108 is configured to communicate to the primary token server 102 and the secondary token server 104. In some embodiments, the mobile user device 108 communicates using the wide area network 106. The wide area network 106 may be a wireless network (e.g., wi-fi), a radio network (e.g., a cellular network, satellite network, or other radio frequency). The mobile user device 108 may include the program application 118 to enable a user to interact with the mobile user device 108. Examples of the program application 118 include a web browser or an executable script. The program application 118 is configured to receive inputs from the user of the mobile user device 108. Users of the mobile user device 108 can access their tickets through, for example, a web-based portal or mobile application.

The token management system 100 can retain the same level of fraud prevention and access to venues as the original vendor desired. In some embodiments, the mobile user device 108 uses a progressive web app (PWA) module, to store tokens offline for users to access without internet access and without the need to download any applications to their device. A PWA feature can be used together with a wallet feature to provide the end user with various ways to access tickets for increased ease of venue entry. Additionally, the token management system 100 does not need to move the original purchased ticket digitally across account holders on the vendor's servers, instead, the secondary token server 104 provides a federated token transfer that allows access to a separately generated identifier that provides a necessary data relating to the original token on the primary token server 102. Because the secondary token server 104 does not require additional communication with the primary token server 102, the tokens can be transferred in a distributed manner (e.g., a federated transfer).

The progressive web app module can provide functionality of an app for the user's device within a website. For example, such functionality can include saving tickets directly to a phone, viewing tickets offline, and/or pushing notifications, all without a user downloading and utilizing an app. Utilization of a PWA provides a level of user freedom and can be advantageously employed where, for example, the user does not want to download and use a ticket vendor's proprietary app.

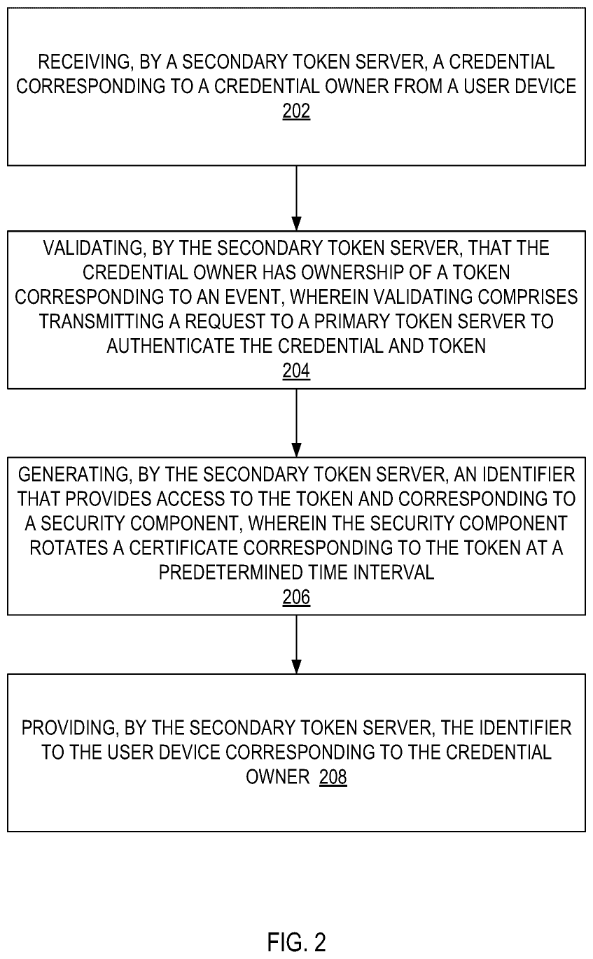

FIG. 2 depicts an example of a federated process for providing an identifier to the user device corresponding to the token owner according to embodiments of the present disclosure. The process 200 may be performed by one or more computing devices.

At operation 202, the process 200 involves receiving, by a secondary token server, a credential corresponding to credential owner from a user device. In some embodiments, the second token server receives. In some embodiments, the secondary token server 104 may receive credential information such as the user account/password, digital certificate, or identity information corresponding to the owner of the mobile user device. The secondary token server 104 validates that the credential owner has ownership of the token by transmitting a validation request to a primary token server 102 to authenticate the token and the credential.

At operation 204, the process 200 involves validating, by the secondary token server, that the token owner has ownership of the token. To validate the token, the secondary token server transmits a request to a primary token server to authenticate the credential and the token. For instance, the secondary token server can receive images of government or privately generated identification of the owner of the mobile user device (e.g., driver's license, school ID, military ID, etc.) and transmit them to the primary token server. In some embodiments, the secondary token server can receive a username/password or other authentication mechanism. The secondary token server may perform an account takeover for an account associated with the primary token server that corresponds to the token owner. After completion of the account takeover, the secondary token server may transfer the token to another device as described below.

At operation 206, the process 200 involves generating, by the secondary token server, an identifier that provides access to the token that corresponds to a security component, wherein the security component rotates a certificate corresponding to the token at a predetermined time interval. The secondary token server may generate a uniform resource locator (URL) and a security component. To generate the URL, the secondary token server may encode a universally unique identifier (UUID) associated with the token in combination with a second parameter such as a current system time, a user profile parameter, an identifier of the event or another parameter from the primary server. The URL can include a one-way hash (e.g., SHA-128, SHA-256) of the UUID and the second parameter.

In some embodiments, there may be multiple secondary token servers such as in different locations with various configuration as necessary to access the primary token server. In these embodiments, each secondary token server may operate as an independent entity (e.g., a federated network) such that tokens associated with a primary token server authorized for events in a particular location remain on the corresponding secondary token server. In other embodiments, the secondary token servers may provide a single account access to multiple primary token servers. In these configurations, the tokens may be stored in a local secondary token server (e.g., a country or location) and be accessible to any secondary token server worldwide.

At operation 208, the process 200 involves providing, by the secondary token server, the identifier to the user device corresponding to the token owner. After generating the identifier, the secondary token server 104 provides the identifier to the mobile user device corresponding to the token owner. The secondary token server 104 provides the identifier by sending the identifier to the mobile user device. In some embodiments, the secondary token server 104 provides the identifier to the web browser of the mobile user device.

In an example using an API implementation, a client can log in to the secondary token server using an HTTP method such as a POST method. The secondary token server can generate a session authentication from the credentials provided to the secondary token server. The session authentication can be dynamically generated upon login POST request, and, if preferred, can be generated periodically, for example every 30 days, to continue gaining access to secondary token server API. An example of an API login request (e.g., credentials of the account owner) can be as follows.

```
{
  “username”: “VBS_Username”,
  “password”: “VBS_Password”
}
```

After authenticating to the secondary token server, the client can provide authentication (e.g., username and password) for a primary token server (e.g., a vendor account). In some embodiments, the client can include one or more events associated with the username. The secondary token server can use the authentication of the primary token server to retrieve all event data associated with the account authenticated by the username and password. For example, a username “Jane Doe” may be associated with valid tokens for events such as “Football Game A,” “Soccer Match B,” and “Golf Tournament C.” An example of an API vendor account request can be as follows.

```
{
  “email”: “Vendor_Email”,
  “password”: “Vendor_Password”,
  “team_name”: “Team_Name”
}
```

During the retrieval, the secondary token server can also fetch event details from the vendor server via a GET method. An API request for fetching event details can depend on various requirements of the primary token server, and can include, for example, event ID, game ID, date, event name, location, status, etc. The secondary token server can tailor the fetch to search for specific events using parameters such as event ID and event details. Multiple events can be retrieved at once from the same account, for example by entering multiple event IDs. An example of an API scan request can be as follows.

```
{
  “eventId”: “Vendor_Account_ID”,
  “ids”: [“Vendor_Event_ID”, “Vendor_Event_ID”],
    “scan”: true,
  “status”: “loaded”
}
```

The secondary token server can fetch event tickets via a GET request. This API request can get ticket data for a specific event. In response to the GET request, the primary token server outputs the data for each valid token to enable identifier generation for the selected tokens. As described above, the secondary token server generates and serves the identifiers (e.g., links) to the client. Additional API requests can include updating account tokens (POST), rescanning the account at the primary token server (POST), and/or revoking identifiers (POST), as well as other requests as may be preferred by the system architect. When re-scanning an account all events, tickets, and links can be erased and the account can be scanned as new. When refreshing an account all events, tokens, and identifiers can be retained. The secondary token server can also be utilized to split a bulk order of tickets and transfer subsets of the tickets to other users. The secondary token server therefore can provide a level of freedom and anonymity to the purchaser of tickets while retaining security and integrity of the token transfer process. The system can provide an anonymous platform that allows free distribution and/or combinations of tokens.

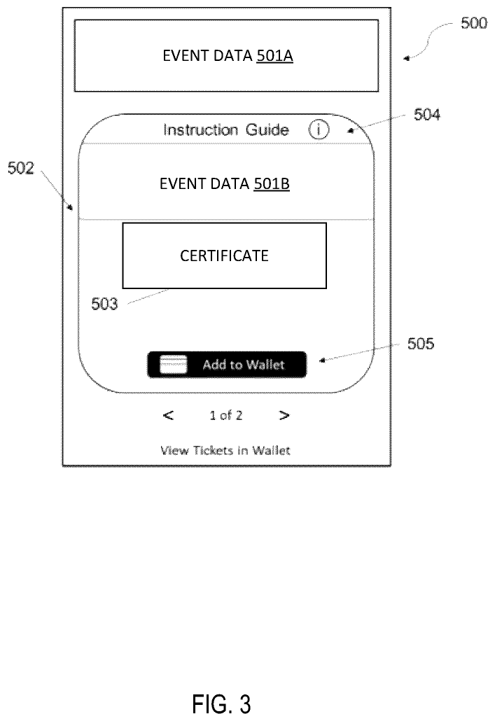

FIG. 3 illustrates an example of a graphical user interface (GUI) 500 for displaying the certificate generated from the token in accordance with embodiments of the present disclosure. As described above, the secondary token system is designed to facilitate the delivery of tickets to end users and make it easy for them to access and use their tickets. In some embodiments, the secondary token system provides the token such that the user can present the certificate using a graphical user interface (GUI) to an access control system 120 to access the event associated with the token. As shown in FIG. 3, a barcode can be presented in a wallet, which can allow downloading of tickets directly to a phone or other device where it can function offline. A rotating barcode can be used, for example, by using the security component associated with the primary token server. In some embodiments, the security component can be implemented using a JavaScript that can be downloaded and executed on a device of the end user. The event details 501A-B can be displayed, as can token data 502, a certificate 503 that is associated with the identifier, and other information. The GUI 500 can include interactive components, such as an instruction guide icon 504 and/or an add-to-wallet feature 505. These components may be existing applications or APIs that are accessible on the device that is presenting the GUI 500. After a token is saved to the wallet on the device, the certificate is accessible without connectivity to the secondary token server or the primary token server.

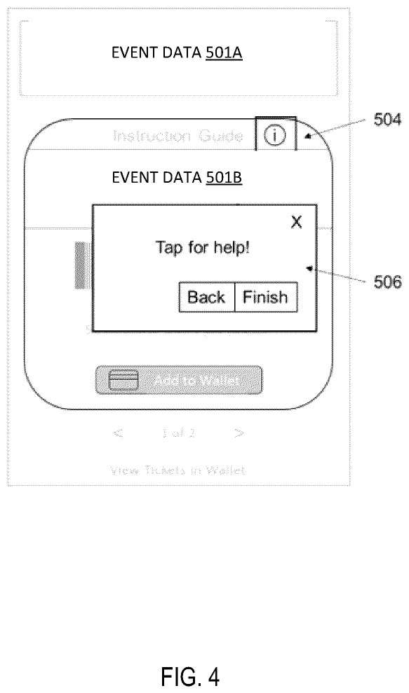

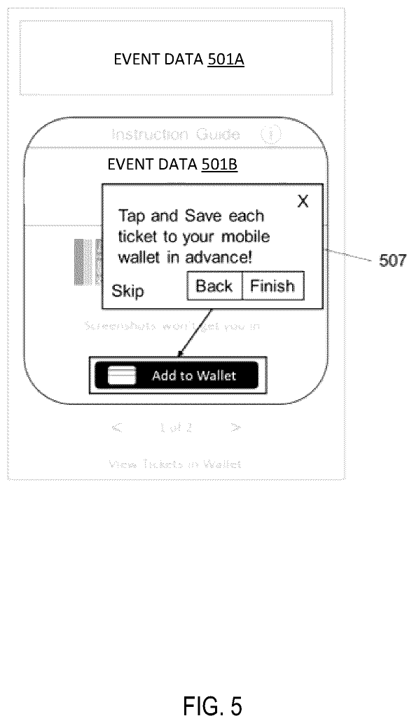

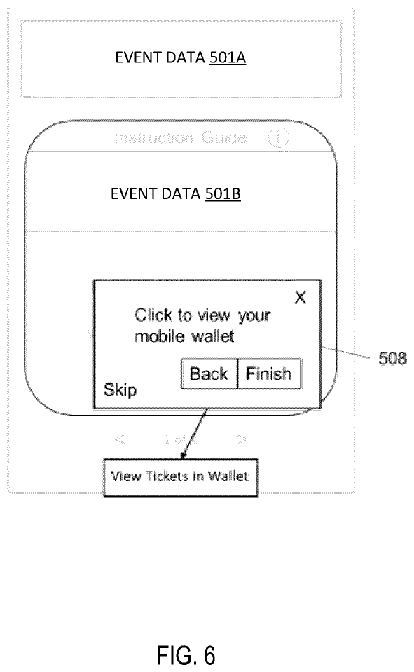

FIGS. 4-6 illustrate a tutorial output on the GUI 500 according to embodiments of the present disclosure. For example, the user interface can display an animation or other indication in response to a selection (e.g., a touch, a voice command) of the identifier. The animation is displayed to present instructions that illustrate an interaction that stores the token on the device of the user. The GUI 500 may present a set of steps that indicate a set of interactions (e.g., a set of buttons to click) that results in the token being stored by a wallet application on the device of the user. As depicted in FIG. 4, a user can click on an instruction guide icon 504 present on the GUI 500. In response to receiving a selection of the instruction guide icon 105, the device may present, via the GUI 500 additional guidance contained in a pop-up box component 506 of the GUI 500. As depicted in FIG. 5, a first instruction output 507 can present one or more instructions on the GUI 500 for how to use an add-to-wallet GUI widget. As depicted in FIG. 5, a second instruction output 508 can present one or more instructions on the GUI 500 for how to view the tokens stored in the wallet application of the device.

The above discussion is meant to be illustrative of the principles and various embodiments of the present invention. All of the methods and systems disclosed and claimed herein can be made and executed without undue experimentation in light of the present disclosure. While the apparatus and methods of this invention have been described in terms of preferred embodiments, it will be apparent to those of skill in the art that variations may be applied to the methods and in the steps or in the sequence of steps of the method described herein without departing from the concept, spirit and scope or the invention.

1. A method of federated token transfer, the method comprising:
receiving, by a secondary token server, a credential corresponding a credential owner from a user device;
validating, by the secondary token server, that the credential owner has ownership of a token corresponding to an event, wherein validating comprises transmitting a request to a primary token server to authenticate the credential and token;
generating, by the secondary token server, an identifier that provides access to the token and corresponding to a security component, wherein the security component rotates a certificate corresponding to the token at a predetermined time interval; and
providing, by the secondary token server, the identifier to the user device corresponding to the credential owner.

2. The method of federated token transfer of claim 1, wherein the identifier is a link to a webpage containing the credential and the security component.

3. The method of federated token transfer of claim 1, wherein the certificate is a barcode or QR code.

4. The method of federated token transfer of claim 1, wherein the identifier is a downloadable package including the certificate generated from the token and the security component.

5. The method of federated credential transfer of claim 4, wherein the token and the security component provides the certificate and access to the event without network connectivity.

6. The method of federated token transfer of claim 1, further comprising transferring the token from the user device to an additional user device associated with a user that is different from the token owner, wherein transferring the token does not require the secondary token server or the primary token server.

7. The method of federated token transfer of claim 6, further comprising providing, by an event ticketing system, access to the event based on the certificate and the additional user device.

8. A non-transitory computer-readable medium, comprising:
a memory storing instructions;
a processor configured to execute the instructions, the instructions causing the processor to perform computing operations for federated token transfer, the operations comprising:
receiving, by a secondary token server, a credential corresponding to a credential owner from a user device;
validating, by the secondary token server, that the credential owner has ownership of the token that corresponds to an event and the credential, wherein validating comprises transmitting a request to a primary token server to authenticate the credential and the token;
generating, by the secondary token server, an identifier that provides access to a certificate corresponding to the token and corresponding to a security component, wherein the security component rotates the certificate at a predetermined time interval; and
providing, by the secondary token server, the identifier to the user device corresponding to the credential owner.

9. The non-transitory computer-readable medium of claim 8, wherein the identifier is a link to a webpage containing the token and the security component.

10. The non-transitory computer-readable medium of claim 9, wherein the token is a barcode or QR code.

11. The non-transitory computer-readable medium of claim 8, wherein the identifier is a downloadable package including the token and the security component.

12. The non-transitory computer-readable medium of claim 11, wherein the token and the security component provides access to the event without network connectivity.

13. The non-transitory computer-readable medium of claim 11, the instructions further causing the processor to perform operations comprising transferring the token from the user device to an additional user device associated with a user that is different from the credential owner, wherein transferring the token does not require the secondary token server or the primary token server.

14. The non-transitory computer-readable medium of claim 13, the instructions further causing the processor to perform operations comprising providing access to the event based on the certificate, the token and the additional user device.

15. A system, comprising:
a primary token server having a stored token corresponding to a user account; and
a secondary token server configured to:
receive a credential corresponding to a user device corresponding to a credential owner;
validate that the credential owner has ownership of the token, wherein validating comprises transmitting a request to the primary token server to authenticate the credential and the token;
generate an identifier that provides access to a certificate corresponding to the token and the credential corresponding to a security component, wherein the security component rotates the certificate at a predetermined time interval; and
provide the identifier to the user device corresponding to the credential owner.

16. The system of claim 15, wherein the identifier is a link to a webpage containing the token and the security component.

17. The system of claim 16, wherein the certificate is a barcode or QR code.

18. The system of claim 15, wherein the identifier is a downloadable package including the token and the security component.

19. The system of claim 18, wherein the token and the security component provides access to the event without network connectivity.

20. The system of claim 15, wherein the secondary token server is further configured to transfer the token from the user device to an additional user device associated with a user that is different from the token owner, wherein transferring the token does not require the secondary token server or the primary token server.
